(19) United States
(12) Patent Application Publication
(10) Pub. No.: US 2010/0173274 A1
(43) Pub. Date: Jul. 8, 2010

(54) METHODS AND SYSTEMS FOR TEACHING MOVEMENTS

(76) Inventor: Sean Hutchison, Beaverton, OR (US)

Correspondence Address: ALLEMAN HALL MCCOY RUSSELL & TUTTLE LLP, 806 SW BROADWAY, SUITE 600, PORTLAND, OR, 97205-3335, US

(21) Appl. No.: 12/646,820

(22) Filed: Dec. 23, 2009

Related U.S. Application Data
(60) Provisional application No. 61/140,793, filed on Dec. 24, 2008.

(51) Int. Cl. G09B 19/00; G09B 5/00

(52) U.S. Cl. 434/258; 434/307 R

(57) ABSTRACT

Methods and systems for teaching movements are provided. One example method for teaching a desired movement to a subject includes presenting an idealized movement stimulus on a display during a presentation period. The method further includes reducing auditory sensory input and visual sensory input to the subject during an absorption period following the presentation period and during a practice period following the absorption period. The method further includes providing movement instruction to the subject to mimic a quality of the idealized movement stimulus with at least a portion of a subject's body during the practice period. The method further includes repeating the presenting and the reducing.

### CROSS-REFERENCE TO RELATED APPLICATIONS

This application claims priority to U.S. Provisional Patent Application No. 61/140,793, filed Dec. 24, 2008 entitled “METHODS AND SYSTEMS FOR LEARNING MOVEMENTS” the entire contents of which are hereby incorporated herein by reference for all purposes.

### BACKGROUND

In athletics and other settings, movements are commonly trained or taught by having subjects practice a desired skill in the actual setting in which the motion normally takes place. For example, athletes tend to practice in settings that highly resemble the setting in which the actual activity will be performed, such as golfers practicing golf swings at a driving range and swimmers practicing specific swim strokes in a pool. This method reflects the common-sense notion that conducting practice in the actual environment of the activity (or a close replication thereof) leads to higher-quality practice and improved performance.

The inventors have recognized that typical training environments include many distractions, and that these distractions can sometimes impede motion training. Distractions can be external, such as noise or visual distractions of other people moving in the periphery. Distractions can also be internal, such as muscle interference or cognitive overload resulting from practicing many movements at once (e.g., moving legs while practicing arm movement for a swimming stroke, practicing both the back swing and follow through of a golf swing). Both external and internal distractions place demands on the neural resources of the person trying to learn the movement. The distractions and consequent neural demands can limit the ability of the subject to consciously and sub-consciously focus on the learning process, thereby reducing the quality of the practice. Further, the distractions and neural demands may potentially limit neuroplastic effects associated with the learning and practice of movements.

### SUMMARY

Methods and systems for teaching movements are provided. One example method for teaching a desired movement to a subject includes presenting an idealized movement stimulus on a display during a presentation period. The method further includes reducing auditory sensory input and visual sensory input to the subject during an absorption period following the presentation period and during a practice period following the absorption period. The method further includes providing movement instruction to the subject to mimic a quality of the idealized movement stimulus with at least a portion of a subject's body during the practice period. The method further includes repeating the presenting of the idealized movement stimulus and the reducing of auditory and visual sensory inputs.

Usage of the methods and systems described herein can lead to improved performance and/or improved retention of the practiced movement, particularly in elite athletes that have been training for incremental improvements over many years. One way in which the methods and systems may improve performance is by accessing and facilitating neuroplasticity associated with the practiced movement. The methods and systems described herein may function to break down previously-learned motor programs (e.g., habitual movement patterns that have been learned and refined over many years), to teach new motor programs, to adjust existing motor programs, and/or to retain a new or adjusted motor program. Furthermore, the unique combination of components of methods described herein may function to improve the practiced movement due to the timing, or schedule, of particular components of the methods. By using the methods described herein, unexpectedly rapid results have been achieved in elite athletes.

This Summary is provided to introduce a selection of concepts in a simplified form that are further described below in the Detailed Description. This Summary is not intended to identify key features or essential features of the disclosed subject matter, nor is it intended to be used to limit the scope of the disclosed subject matter. Furthermore, the disclosed subject matter is not limited to implementations that solve any or all disadvantages noted in any part of this disclosure.

### BRIEF DESCRIPTION OF THE DRAWINGS

FIG. 1 is a flowchart illustrating an example method for teaching a desired movement.

FIG. 2 is a schematic view of a system for teaching a desired movement.

### DETAILED DESCRIPTION

In the realm of elite athletics, it is often very difficult and/or time consuming for athletes to achieve significant improvements in performance. For example, an elite swimmer may train for several years to shave off fractions of seconds in a 100 meter freestyle swim race. As another example, a professional golfer might work very hard to make subtle changes in his golf swing in order to increase the distance of his tee shots by a few yards. Methods are described herein for training movements (e.g., movements employed in an athletic activity) in a novel way that more efficiently uses the neural movement-learning capacity of a subject. In athletics and other endeavors, use of the methods can rapidly produce significant improvements, even in individuals that are already highly trained.

An exemplary method includes carrying out one or more movement learning sessions in a distraction-free environment, where each learning session includes at least one presentation period, at least one absorption period, and at least one practice period. For example, for teaching a swimming movement, a subject (e.g., an athlete) may be situated in a distraction-free environment, and presented with a video of an elite swimmer performing the desired swimming movement for the presentation period. In this example, the video functions as an idealized movement stimulus, or idealized athletic movement, for the subject to focus on during the presentation period. By reducing distractions and sensory inputs to the subject, the subject's neural resources may be maximally focused on the video and any other sensory stimulus to which the subject is exposed (e.g., audio prompts to focus on a particular aspect of the movement). Following the presentation period, an absorption period may be provided wherein the subject can focus on, or mentally re-play, one or more qualities of the idealized swimming movement in the distraction-free environment. During the absorption period, it is believed that the subject's mirror neurons are activated, and that such activation is made more efficient as a result of the stimulus-controlled environment in which the idealized movement is presented. Following the absorption period, the subject may engage in a practice period to mimic a desired quality or aspect of the idealized swimming movement, also in the distraction-free environment. It is believed that the unique combination of the distraction-free environment with the processes and tools described herein allows for an improved amount of focus by a subject, thus enabling more efficient learning at a neuro-physiological level.

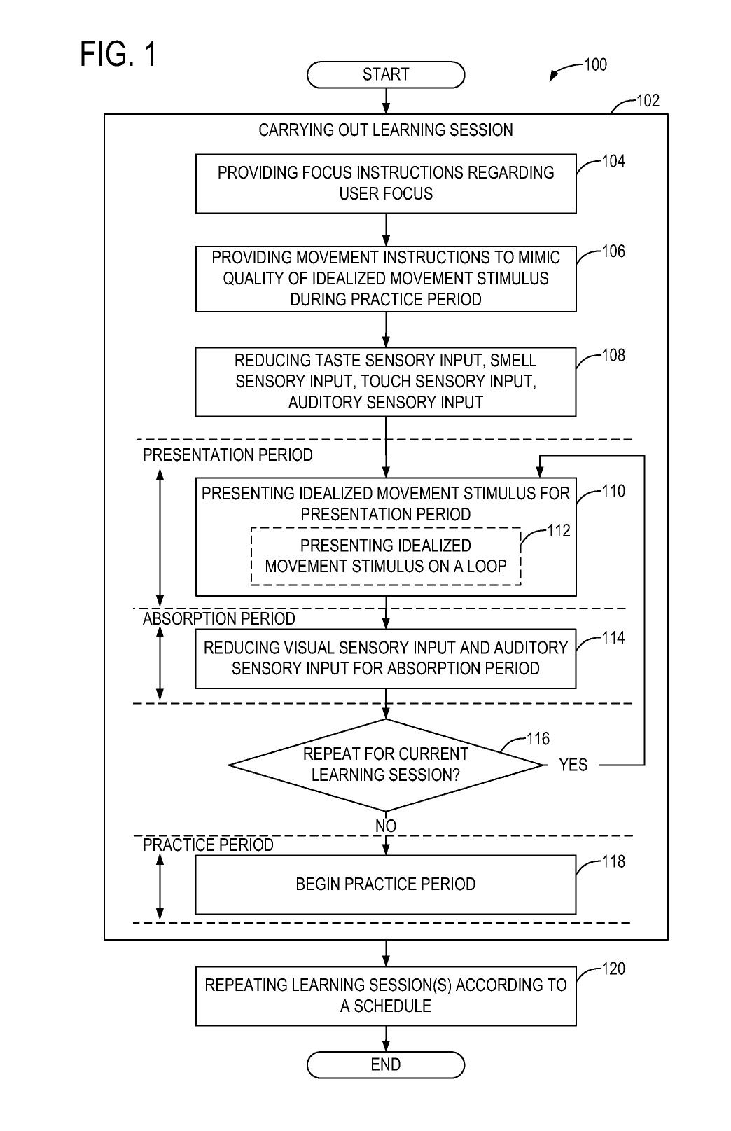

FIG. 1 illustrates a method 100 for teaching or training a desired movement to a subject. At 102, the method 100 includes carrying out a learning session. Carrying out the learning session may include, at 104, providing focus instructions to the subject regarding subject focus during an upcoming presentation period, absorption period, and/or practice period. That is, the focus instructions are provided to the subject before the presentation period, for the subject to apply the focus instructions during one or more of the presentation period, the absorption period, and the practice period. As one example, when teaching a swimming movement, the focus instructions may include instructions to focus on a swimmer's dynamic arm angle in a video presented to the subject during the presentation period. The focus instructions may additionally include instructions to focus on mentally re-playing the dynamic arm angle during the absorption period, and instructions to focus on mimicking the dynamic arm angle during the practice period.

At 106, carrying out the learning session includes providing movement instructions to the subject. Like the focus instructions of 104, the movement instructions of 106 are provided before the practice period in this example, and the movement instructions are to be followed, or applied, when the practice period begins. As such, the movement instructions may include instructions to mimic a quality of an idealized movement stimulus with at least a portion of the subject's body, during an upcoming practice period. For the example of teaching the swimming movement, movement instructions may include instructions to mimic the movement of the swimmer video with an arm of the subject's body at a practice speed similar to the speed of the swimming movement in the video. The practice speed may be a speed that is slower than a normal performance speed. The movement instructions may alternately include instructions to mimic the movement at a plurality of practice speeds.

The quality of the idealized movement stimulus to be mimicked may include any aspect of the idealized movement stimulus. For example, the quality to be mimicked may be movement of only a portion of the moving body such that a subject is instructed to perform only the movement of the wrist after watching a swimming movement involving an entire arm. As other examples, the quality of movement to be mimicked may include a joint angle, a speed of a movement, a degree of limb extension or contraction, etc.

One or more of the focus instructions of 104 and the movement instructions of 106 may be communicated verbally (e.g., from a computing device, from a coach, from an instructive provider via headphones, etc.) or may be communicated visually (e.g., presented on a display, presented as text on paper, etc.).

To reduce distractions available to the subject, carrying out the learning session may include, as shown at 108, reducing taste sensory input, smell sensory input, touch sensory input, and/or auditory sensory input. The reduction of sensory inputs at 108 may include elimination of sensory input, such that a sensory-deprived environment can be created for the subject. Alternately, the reduction of sensory inputs at 108 may include providing the subject with near-constant or constant sensory stimuli in order to “dull” the senses (e.g., “white noise”), thus reducing novel sensory stimuli (e.g., distractions).

As some examples, the subject may be provided with resources to neutralize a taste in the subject's mouth, such as a mouth rinse. To reduce smell sensory input, the subject's environment may be smell-neutralized and/or the subject may be outfitted with nose plugs. Further still, touch sensory input to the subject may be reduced by reducing contact of items with one or more portions of the subject's body (e.g., the subject may be prevented from using objects to support the body). Auditory sensory input, or auditory distractions, may be reduced at 108 by the provision or existence of sound-proof walls in the learning session room, by providing the subject with soundproof headphones, and/or by delivering white noise to the subject. Furthermore, visual distractions in the subject's external environment may be reduced during the learning session. For example, visual distractions may be reduced by providing black-out drapes upon surfaces of the space within which the learning session is carried out. That is, black-out drapes may be provided over walls of a learning session kiosk, over windows and walls of a learning session room, etc. It may be appreciated that the reduction of sensory inputs described at 108 may take place at any time before or during a learning session.

At 110, carrying out the learning session includes presenting an idealized movement stimulus to a subject for the presentation period, while the subject is in the sensory-reduced environment. The idealized movement stimulus may include a video clip displayed to the subject and/or an auditory cue communicated to the subject. For example, a swimmer wishing to improve a backstroke movement may be shown a video of an idealized backstroke, such as that performed by an Olympic swimmer As other examples, an idealized movement stimulus may include a video of an animal performing a movement to be learned, an animation of a movement to be learned, such as a 2-dimensional or 3-dimensional animation of an avatar, or wire frames and drawings performing the movement.

The presenting may include, at 112, presenting the idealized movement stimulus repetitively, on a loop, such that the idealized movement stimulus is repetitively displayed for a prescribed duration (e.g., 1-10 minutes) of the presentation period. With respect to the swimming backstroke example, a video demonstrating a portion of a backstroke (e.g., an in-water portion of the backstroke, an out-of water portion of the backstroke) may be looped such that when the video reaches the end, it returns to play the video from the beginning. The looped content may be played at a reduced speed (e.g., slower than real movement) to facilitate subject comprehension and/or learning. During the presentation period, the subject may follow the focus instructions of 104 and focus on an aspect of the idealized movement stimulus being presented. In some cases, it may be desirable to provide the focus instructions during the presentation of the idealized movement, in addition to or instead of providing the instructions beforehand.

At 114, carrying out the learning session includes reducing visual sensory input and auditory sensory input for an absorption period to facilitate the subject's absorption of the idealized movement stimulus. With regard to the swimming backstroke example, the video of an idealized backstroke may be turned off for the absorption period, and the subject may be subjected to darkness, the absence of auditory information, and/or other artificially generated sensory inputs, to create a sensory-reduced or sensory-deprived environment for the subject. By reducing sensory input to the subject, the subject's attention can be more easily focused on absorbing the idealized movement stimulus according to the focus instructions provided at 104, which may include instructions to mentally replay, mentally practice, and/or memorize a particular quality of the idealized movement stimulus during the absorption period. The reduction of distractions may enhance the subject's ability to consciously and/or unconsciously focus on the idealized movement stimulus and the motion being trained. The instructions of step 104 may include providing auditory prompts to the user during the absorption/visualization period, for example, audio suggestions to focus on a particular aspect of the movement that was shown to the subject.

At 116, it is determined if the presenting at 110 and/or reducing at 114 are to be repeated, based on a learning session structure. It may be appreciated that the learning session structure may be customized based on the subject, a type of subject, a sport being taught, a movement being taught, a number of total learning sessions, etc.

If the answer is yes at 116, carrying out the learning session may include repeating the presenting at 110 followed by the reducing at 114. In another example where the answer is yes at 116, carrying out the learning session may include repeating one of the presenting at 110 and the reducing at 114.

It may be appreciated that components of a learning session may be implemented in various intervals or sequences. For example, a swimmer learning a movement within a learning session may be presented with an alternating backstroke video for several minutes and an absorption period of several minutes in the sensory-reduced environment such that the presenting at 110 and reducing at 114 are each carried out more than once. However, in other examples, the presenting at 110 and reducing at 114 may be carried out only once within a learning session. It may be further appreciated that any or all of the components of the learning session may be repeated a predetermined number of times within a learning session.

If the answer is no at 116, carrying out a learning session includes proceeding to 118 where the practice period begins. The subject may practice a desired quality of the idealized movement stimulus during the practice period, according to focus instructions of 104 and/or movement instructions of 106, either or both of which may be repeated during the practice period. The subject may mimic, or practice the motion presented in the idealized movement stimulus in various ways. Some or all of the practice period can be performed in the sensory-reduced environment or sensory-deprived environment that is provided for the absorption period (e.g., with reduced visual sensory input and auditory sensory input). In the context of training a golfer, for example, it may be desirable to have initial practice swings performed while the golfer is blindfolded during the practice period, thereby improving the golfer's ability to visualize the idealized movement stimulus.

Also, in many cases it will be preferable that one or more repetitions of the trained movement be performed at a slow speed, and/or with an emphasis on the form of the motion, as opposed to performing the swim stroke, golf swing, etc. at the normal speed/pace of the activity. As such, a subject may be instructed to practice the quality of the idealized movement stimulus at one or more practice speeds that are slower than a competitive performance speed or a conventional practice speed in order to facilitate new learning of specific aspects of the movement. As may be appreciated, users of the method 100 described herein may be accomplished athletes with years of practice of the movement being trained. By slowing down the movement practice from a common practice speed, in combination with other steps of method 100, the subject may be able to unlearn an old and ingrained style of performing the movement and relearn the movement by mimicking a quality of the idealized movement stimulus. In addition to these modifications from the normal context of the motion, it will also be desirable in some examples to include practice repetitions that replicate the actual activity (e.g., a swim stroke performed at “race pace”).

The practice period may be any duration (e.g., 1-30 minutes). In some examples, a duration of the practice period is proportional to a duration of the presentation period. For example, if the duration of the presentation period is 1 minute, the duration of the practice period is also 1 minute.

In another embodiment, and as previously indicated, the subject may be sent visual or auditory instructions during or between any of the steps of the method 100, regarding desired subject activity during the learning session. For example, the subject may be provided with focus instructions during the presentation period and provided with movement instructions during the practice period. For example, movement instructions provided during the practice period may describe to a subject how to practice the quality of the desired movement (e.g., slow vs. fast, number of times to practice, when to stop practicing, etc.).

It may be appreciated that each of the presentation period, absorption period, and practice period can be implemented for a predetermined duration, a predetermined number of times, at a predetermined schedule, and/or at a predetermined pace within a learning session. For example, steps 110, 114, and 118 may be repeated as a unit within a learning session.

Furthermore, each of the presentation period, absorption period, and practice period can be implemented for a predetermined duration, a predetermined number of times, at a predetermined schedule, and/or at a predetermined pace over a plurality of learning sessions. As such, the method 100 includes repeating one or more learning sessions (e.g., some or all of the steps of the learning session) according to a schedule at 120. Such a schedule may include carrying out the learning session between 2-7 times per week for a period of 1-3 months, as just one example.

By reducing distractions and facilitating accurate focusing of the subject's neural resources on the idealized movement stimulus during the presentation period, absorption period, and/or practice period, the method 100 may have the benefit of improving performance by a measurable amount and/or may improve retention of an improvement. One way in which the method 100 described herein may result in sustained improved performance and/or retention is by the facilitation of neuroplasticity associated with the mentally and physically practiced movement.

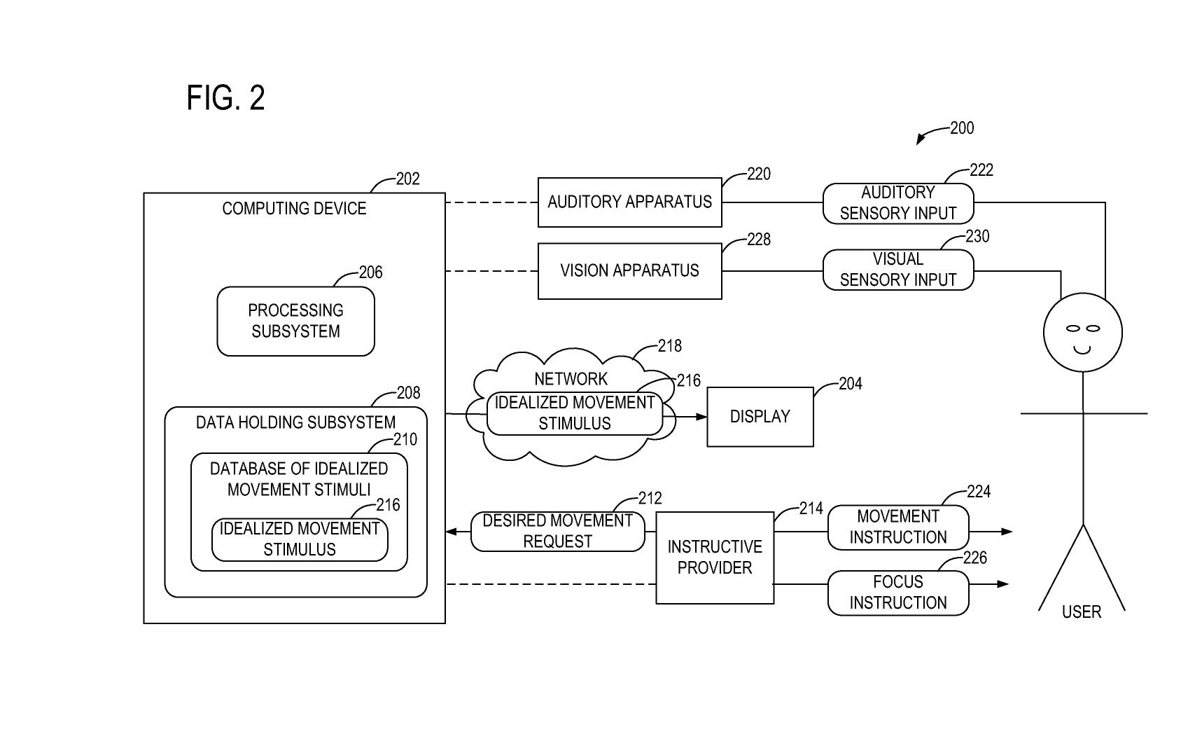

Turning now to FIG. 2, a schematic view of an exemplary system 200 that can be used for teaching a desired movement to a subject is illustrated. The system 200 includes a computing device 202 and a display 204 coupled to the computing device 202. The computing device 202 includes a processing subsystem 206 (e.g., processor) and a data holding subsystem 208 (e.g., hard drive, memory, etc.).

The data holding subsystem 208 may include a database 210 of idealized movement stimuli, such as indexed and/or searchable video footage, modeled idealized movement stimuli, and/or auditory instructions for a plurality of movements, as some examples. It may be appreciated that the plurality of idealized movement stimuli available in the database 210 may be categorized in predefined movement categories (e.g., upper limb swim stroke, lower limb swim stroke, golf back-swing, golf swing follow through, etc.) to reduce the complexity of searching, as well as to reduce the complexity of the movement to be learned by the subject. By reducing the complexity of the movement, the efficacy of the methods and systems described herein may be increased by reducing demands placed on the neural system of a subject during a learning session.

The computing device 202 may communicate with various other devices or people in the system 200 (e.g., via an I/O interface). As shown, the computing device 202 may receive a desired movement request 212 from an instructive provider 214 (e.g., a coach, trainer, etc.). For example, a coach may search the database 210 for a desired movement via interaction with a graphical user interface on the display 204. In such a case, the computing device 202 may receive the desired movement request 212 over a network 218 (e.g., local area network, Internet, etc.). In yet another example, a second display may be provided for displaying a graphical user interface for a coach or administrator to interact with to send a desired movement request, while display 204 is reserved for the display of idealized movement stimuli.

The computing device 202 may include code executable by the processing subsystem 206 to select an idealized movement stimulus 216 from the database 210 based on the desired movement request 212. In some examples, the selection of the idealized movement stimulus may be automatically selected to present a specific component or aspect of a desired movement. For example, the idealized movement stimulus may be automatically selected based on an accuracy of the movement being demonstrated by the idealized movement stimulus.

On the other hand, semi-automatic or manual selection of an idealized movement stimulus may be desired. That is, for some desired movement requests, there may be several idealized movement stimuli contained in the database 210 of idealized movement stimuli that meet a criterion for selection. For example, if a desired movement request includes a swimming backstroke, and the database includes several videos of a swim backstroke (e.g., each video portrays the swim backstroke from a different camera angle, such as bird's-eye view, perspective view, front view, etc.), the several videos may be returned in a list on the graphical user interface whereby a subject can manually select a preferred video for display as the idealized movement stimulus.

After the idealized movement stimulus has been selected, the computing device 202 may communicate with display 204 to present the idealized movement stimulus 216 on the display 204 for a presentation period. As previously mentioned, the idealized movement stimulus 216 may be repetitively displayed, on a loop, for a duration of the presentation period. The processing subsystem 206 may be employed to display video on display 204, from the data holding subsystem 208.

For a golfer, an idealized movement stimulus may include video footage of a professional golfer performing a backswing, responsive to a desired movement request for a golf backswing. In an acrobatics example, the idealized movement stimulus may include a video of a mathematically-generated model of an idealized backflip, responsive to a desired movement request for a backflip.

The idealized movement stimulus 216 may include a video clip and/or an auditory cue. Sometimes, the idealized movement stimulus may lack a visual component such that instead of displaying the idealized movement stimulus, the idealized movement stimulus is audibly broadcast using, for example, speakers. In such an example, visual sensory input may be reduced during the presentation period.

In order to provide instructions to the subject for a learning session, the system 200 includes an instructive provider 214. The instructive provider 214 may be a person (e.g., a coach) or may be an element of computing device 202 or an element of a different computing device coupled to computing device 202.

The instructive provider 214 may provide focus instruction 226 to the subject regarding how the subject is to focus his/her attention during the presentation period, absorption period, and/or practice period. In one example, the focus instruction 226 may include a generic focus instruction that is independent of a selected idealized movement stimulus (e.g., “focus eyes on screen during presentation period”). In such a case, the instructive provider 214 may provide a stock set of focus instructions. In another example, the instructive provider 214 may provide customized focus instruction. For example, a coach may instruct a golfer to focus on a beginning portion of a golf backswing video during the presentation period, to mentally replay the back swing rhythm during the absorption period, and to practice the back swing rhythm during the practice period, based on the coach or golfer's desire to improve the golfer's back swing.

The instructive provider 214 may also provide movement instruction 224 to a subject from a knowledge database of instructions. Thus, upon knowing the desired movement request 212 and/or selected idealized movement stimulus 216, the instructive provider 214 can select and communicate movement instruction 224 to the subject. The movement instruction 224 can include instruction to mimic a quality of the idealized movement stimulus 216 during a practice period following the absorption period.

The movement instruction 224 may also include instruction regarding a speed at which to practice during the practice period. In some cases, the movement instruction 224 may indicate that a desired movement is to be practiced at a plurality of speeds, some or all of which may be less than a competitive performance speed, or less than a normal practice speed in order to facilitate learning. On the other hand, the movement instruction 224 may include instructions to practice at one speed that is less than or equal to the competitive performance speed, or less than or equal to the normal practice speed.

The system 200 also includes components to control sensory inputs to thereby create a distraction-free environment for the subject. By controlling sensory inputs available to the subject during a learning session, future subject performance and retention of the practiced movement may be improved by facilitating neuroplasticity associated with improved performance and retention of the practiced movement.

Accordingly, system 200 includes an auditory apparatus 220, such as headphones. The auditory apparatus 220 may be configured to communicate one or more of the focus instruction 226 and movement instruction 224 to the subject before presenting the idealized movement stimulus 216 on the display 204. The auditory apparatus 220 may be configured to communicate auditory instructions to the subject, for example, from the instructive provider 214.

If the idealized movement stimulus 216 includes an auditory cue, the auditory apparatus 220 may communicate said auditory cue to the subject. However, if auditory cues are not included as an element of idealized movement stimulus 216 (e.g., the video is silent), the auditory apparatus 220 may reduce auditory sensory input 222 during the presentation period. The auditory apparatus may also be configured to reduce auditory sensory input 222 to the subject for an absorption period and/or the practice period. In such a case, the headphones may be sound-proofing headphones. In another example, headphones may deliver white noise to the subject during an absorption period and/or practice period so as to reduce an auditory sensory input variability (e.g., to minimize auditory distractions).

As shown, the system 200 also includes a vision apparatus 228 for controlling visual sensory input. During at least the absorption period and sometimes during the practice period, visual sensory input 230 is reduced. The vision apparatus 228 may be a blindfold so as to induce visual blackness.

As another example, the vision apparatus may include a set of goggles coupled to the display 204 and/or computing device 202 such that the idealized movement stimulus 216 is displayed on a surface of the goggles during the presentation period, and such that the surface of the goggles is darkened for the absorption period and/or practice period. The goggles may wirelessly communicate with a base station containing the data holding subsystem 208, such that the idealized movement stimulus 216 (e.g., video) can be transmitted from the data holding subsystem 208 in the base station to the subject wearing the goggles. Likewise, an element of the distraction-free environment (e.g., absence of visual input) can be achieved by blacking out the display screens of the goggles. Such a set of goggles may be waterproof and/or weatherproof such that they can be used under a multitude of practice conditions (e.g., for swimmers, skiers, etc.). In another example, the goggles may be outfitted with a waterproof compartment, or port, in which a portable hard drive containing components of the computing device 202 (e.g., data holding subsystem 208, processing subsystem 206) can be inserted.

In general, the components of the system 200 may exist on several servers or computing devices, such that the functionality of the system 200 is distributed. For example, a server may include the data holding subsystem 208, from which data can be transmitted, or downloaded, to a client subsystem coupled to the display 204. In one example, the display 204 is an in-room projection system having an associated 2-D or 3-D display screen (e.g., high definition screen) and speaker system, configured to communicate with the server containing the remaining components of the computing device 202. In this example, video can be displayed on the display screen, via the projection system, the screen can be made black in a darkened room to reduce visual sensory input, and speakers can be silenced to reduce auditory sensory input.

Further still, another example of the display 204 includes a 2-D or 3-D personal head-mounted display. The 2-D or 3-D display may include both a visual display and a speaker system, such that the personal head-mounted display can receive the idealized movement stimulus 216 (e.g., video, auditory instructions), the auditory sensory input 222 and the visual sensory input 230 (e.g., reduction of auditory and/or visual input) for provision to the subject. Such a head-mounted display may be configured to wirelessly communicate with a server or computing device 202. Alternately, the head-mounted display may be physically coupled to the computing device 202. Further still, the head-mounted display may include a port for insertion of a portable hard drive containing the computing device 202.

It may be appreciated that any or all portions of the computing system 200 described herein may be designed to be waterproof or otherwise damage-resistant, to increase the contexts within which the system 200 and corresponding method can be implemented.

It may be further appreciated that the display 204 may be configured to deliver idealized movement stimuli in a non-visual manner. For example, an idealized movement stimulus may be delivered in the form of auditory instructions, and/or somatosensation associated with the movement. In such a case, the output subsystem may be replaced with a device appropriate for delivering the idealized movement stimuli in the desired modality.

The system and methods disclosed herein may be applied in many contexts as they apply to movement, including training and refining athletic skills and movements, rehabilitation training, military training, educational tutoring, personal training, and musical instrument tutoring, as some examples. Some particular settings for which the described methods and systems may be applicable include baseball, bowling, gymnastics, diving, and any other sport or setting involving learned movements. Furthermore, the system and methods disclosed herein can be carried out by a single subject, or by several subjects, such as a coach and an athlete.

The computing devices described herein may be any suitable computing device configured to execute the programs described herein. For example, the computing devices may be a mainframe computer, personal computer, laptop computer, portable data assistant (PDA), computer-enabled wireless telephone, networked computing device, or other suitable computing device, and may be connected to each other via computer networks, such as the Internet. These computing devices typically include a processor and associated volatile and non-volatile memory, and are configured to execute programs stored in non-volatile memory using portions of volatile memory and the processor. As used herein, the term “program” refers to software or firmware components that may be executed by, or utilized by, one or more computing devices described herein, and is meant to encompass individual or groups of executable files, data files, libraries, drivers, scripts, database records, etc. It will be appreciated that computer-readable media may be provided having program instructions stored thereon, which upon execution by a computing device, cause the computing device to execute the methods described above and cause operation of the systems described above.

It should be understood that the embodiments herein are illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

1. A method for teaching a desired movement to a subject, the method comprising:
presenting an idealized movement stimulus on a display during a presentation period;
reducing auditory sensory input and visual sensory input to the subject during an absorption period following the presentation period and during a practice period following the absorption period;
providing movement instruction to the subject to mimic a quality of the idealized movement stimulus with at least a portion of a subject's body during the practice period; and
repeating the presenting and the reducing.

2. The method of claim 1, wherein the presenting includes repetitively presenting the idealized movement stimulus on a loop during the presentation period.

3. The method of claim 1, wherein the repeating includes carrying out a plurality of learning sessions according to a schedule, each learning session including at least one presentation period, at least one absorption period, and at least one practice period.

4. The method of claim 1, wherein the presentation period has a duration of 1-10 minutes, and wherein the practice period has a duration that is proportional to the duration of the presentation period.

5. The method of claim 1, wherein providing movement instruction includes providing instruction to mimic the quality of the idealized movement stimulus at a plurality of practice speeds.

6. The method of claim 1, wherein providing movement instruction includes providing instruction to mimic the quality of the idealized movement stimulus at a practice speed that is slower than a performance speed.

7. The method of claim 1, further comprising providing focus instruction to the subject regarding subject focus during the presentation period, the absorption period, and the practice period.

8. The method of claim 1, further comprising reducing one or more of taste sensory input, smell sensory input, and touch sensory input to the subject.

9. A method for teaching a desired athletic movement to a subject, the method comprising:
presenting a video of an idealized athletic movement, repetitively, for a duration of a presentation period;
reducing auditory sensory input to the subject during the presentation period, during an absorption period following the presentation period, and during a practice period following the absorption period;
reducing visual sensory input to the subject during the absorption period and during the practice period;
providing movement instruction to a subject to perform an actual movement at a predetermined pace, the movement instruction including instruction to mimic a quality of the idealized athletic movement during the practice period; and
carrying out a plurality of learning sessions according to a schedule, each learning session including at least one presentation period, at least one absorption period, and at least one practice period.

10. The method of claim 9, further comprising reducing one or more of taste sensory input, smell sensory input, and touch sensory input to the subject during the presentation period, the absorption period, and the practice period.

11. The method of claim 9, wherein the duration of a presentation period is proportional to a duration of the practice period.

12. The method of claim 9, wherein providing movement instruction includes providing instruction to mimic the quality of the idealized athletic movement at a practice speed that is slower than a performance speed.

13. A system for teaching a desired movement to a subject, the system comprising:
a display;
a computing device coupled to the display, the computing device including:
a processing subsystem;
a data holding subsystem including a database of searchable idealized movement stimuli; and
code executable by the processing subsystem to:
receive a desired movement request;
select an idealized movement stimulus from the database based on the desired movement request;
present the idealized movement stimulus on the display for a presentation period;
an auditory apparatus for reducing auditory sensory input for an absorption period following presentation of the idealized movement stimulus; and
an instructive provider for providing movement instruction to a subject, the movement instruction including instructions to mimic a quality of the idealized movement stimulus during a practice period following the absorption period.

14. The system of claim 13, further comprising a vision apparatus for reducing visual sensory input during the absorption period.

15. The system of claim 14, wherein the vision apparatus includes goggles coupled to the display such that the idealized movement stimulus is presented on a surface of the goggles during the presentation period, and such that the surface of the goggles is darkened for the absorption period.

16. The system of claim 13, wherein the idealized movement stimulus includes a video clip and an auditory cue.

17. The system of claim 13, wherein the code is executable to present the idealized movement stimulus on a loop such that an idealized movement is repetitively displayed during the presentation period.

18. The system of claim 13, wherein the instructive provider is further configured to provide focus instructions regarding subject focus during the presentation period, the absorption period, and the practice period.

19. The system of claim 13, wherein movement instruction provided by the instructive provider also includes instructions to mimic the quality of the idealized movement stimulus at a predetermined practice speed.

20. The system of claim 13, wherein the auditory apparatus communicates auditory instructions to the subject from the instructive provider.
